(19) United States
(12) Patent Application Publication
(10) Pub. No.: US 2024/0351289 A1
(43) Pub. Date: Oct. 24, 2024

(54) PRINTING CONTROL METHOD, STORAGE MEDIUM, AND MULTI-SUPPLY AUTOMATIC SWITCHING EXTRUSION APPARATUS

(71) Applicant: SHENZHEN ANYCUBIC TECHNOLOGY CO., LTD., Shenzhen (CN)

(72) Inventor: Qiming LIAO, Shenzhen (CN)

(73) Assignee: SHENZHEN ANYCUBIC TECHNOLOGY CO., LTD., Shenzhen (CN)

(21) Appl. No.: 18/757,773

(22) Filed: Jun. 28, 2024

Related U.S. Application Data
(63) Continuation of application No. PCT/CN2022/143861, filed on Dec. 30, 2022.

(30) Foreign Application Priority Data
Dec. 30, 2021 (CN) 202111666282.5

(51) Int. Cl. B29C 64/393; B29C 64/321; B29C 64/35; B33Y 30/00; B33Y 40/00; B33Y 50/02

(52) U.S. Cl. CPC B29C 64/393; B29C 64/321; B29C 64/35; B33Y 30/00; B33Y 40/00; B33Y 50/02

(57) ABSTRACT

A printing control method, storage medium, and a 3D printing device, applicable in a multi-supply automatic switching extrusion apparatus, includes: if a supply replacement signal is acquired, identifying a target feeding channel corresponding to the supply replacement signal; controlling a supply corresponding to a current feeding channel to return to a set position, and while the supply corresponding to the current feeding channel is returning to the set position, cutting off an end portion of the supply corresponding to the current feeding channel; and controlling an end portion of a supply corresponding to the target feeding channel to move to a printhead of a 3D printer, thus allowing the 3D printer to continue to execute a printing action. The present invention implements the automatic switching of multiple supplies without requiring manual operation and ensures that blocking and jamming of a supply are avoided when the supply is used again.

### CROSS REFERENCE TO THE RELATED APPLICATION

This application is a continuation application of International Application No. PCT/CN2022/143861 filed on Dec. 30, 2022, which is based upon and claims priority to Chinese Patent Application No. 202111666282.5, filed on Dec. 30, 2021, the entire contents of which are incorporated herein by reference.

### TECHNICAL FIELD

The present invention relates to the technical field of 3D printing, and in particular to a printing control method, a storage medium, and a multi-supply automatic switching extrusion apparatus.

### BACKGROUND

A conventional 3D printer, for example, a fused deposition 3D printer, generally uses multiple extruders with a single or dual nozzles to print supplies (consumables) of multiple colors and supplies of different materials. When the supplies are varied in color and material, the number of extruders used is large, which seriously increases the production cost. Moreover, due to the large number of extruders, the process of switching the supplies of different colors and materials is complicated and inconvenient.

### SUMMARY

In view of the above problems, the present invention provides a printing control method, a storage medium, and a multi-supply automatic switching extrusion apparatus in order to overcome or at least partially solve the above problems.

According to a first aspect of the present invention, provided is a printing control method, applicable in a multi-supply automatic switching extrusion apparatus, the multi-supply automatic switching extrusion apparatus being provided with a supply extrusion module for driving a supply in the feeding channel to enter the discharging channel or to return, and the multi-supply automatic switching extrusion apparatus further including a plurality of feeding channels, one discharging channel, and a cutting module on the discharging channel. The method includes:
if a supply replacement signal is acquired, identifying a target feeding channel corresponding to the supply replacement signal;
controlling a supply corresponding to a current feeding channel to return to a set position, and while the supply corresponding to the current feeding channel is returning to the set position, cutting off an end portion of the supply corresponding to the current feeding channel; and
controlling an end portion of a supply corresponding to the target feeding channel to move to a printhead of a 3D printer, thus allowing the 3D printer to continue to execute a printing action.

Optionally, the step of, if a supply replacement signal is acquired, identifying a target feeding channel corresponding to the supply replacement signal comprises: if a preset supply replacement signal is read in a print file, identifying a target feeding channel corresponding to the supply replacement signal.

Optionally, the multi-supply automatic switching extrusion apparatus is provided with a supply extrusion module for driving a supply in the feeding channel to enter the discharging channel or to return, the multi-supply automatic switching extrusion apparatus further includes a plurality of feeding channels, one discharging channel, and a cutting module on the discharging channel, and the step of controlling a supply corresponding to a current feeding channel to return to a set position, and while the supply corresponding to the current feeding channel is returning to the set position, cutting off an end portion of the supply corresponding to the current feeding channel includes:
controlling, by the supply extrusion module, a supply corresponding to a current feeding channel to return to a first set position;
controlling the supply cutting module to cut off an end portion of the supply corresponding to the current feeding channel; and
controlling, by the supply extrusion module, the supply corresponding to the current feeding channel to return to a second set position.

Optionally, the discharging channel is correspondingly provided with a discharging position sensor, and each of the feeding channels is correspondingly provided with a feeding position sensor;
the step of controlling, by the supply extrusion module, a supply corresponding to a current feeding channel to return to a first set position includes:
controlling, by the supply extrusion module, the supply corresponding to the current feeding channel to return, and if a material run-out signal corresponding to the discharging position sensor is acquired, controlling, by the supply extrusion module, the supply corresponding to the current feeding channel to further return by a first preset distance; and
the step of controlling, by the supply extrusion module, the supply corresponding to the current feeding channel to return to a second set position includes:
controlling, by the supply extrusion module, the supply corresponding to the current feeding channel to return, and if a material run-out signal corresponding to the feeding position sensor is acquired, stopping, by the supply extrusion module, the movement of the supply corresponding to the current feeding channel.

Optionally, the multi-supply automatic switching extrusion apparatus is provided with a supply extrusion module for driving a supply in the feeding channel to enter the discharging channel or to return, the multi-supply automatic switching extrusion apparatus further includes a plurality of feeding channels, one discharging channel, and a cutting module on the discharging channel, the discharging channel is correspondingly provided with a discharging position sensor, and the step of controlling an end portion of a supply corresponding to the target feeding channel to move to the printhead of the 3D printer includes: controlling the supply extrusion module to switch to a position corresponding to a target channel, and causing the supply corresponding to the target feeding channel to enter the discharging channel; and if a material-available signal corresponding to the discharging position sensor is acquired, controlling a supply corresponding to the target feeding channel to advance by a second preset distance.

Optionally, before the step of controlling a supply corresponding to a current feeding channel to return to a first set position, the method further includes:
controlling a supply corresponding to a current feeding channel to return; and
if a material run-out signal corresponding to the discharging position sensor is acquired, recording a return distance of the supply, and taking the distance as the second preset distance.

Optionally, the multi-supply automatic switching extrusion apparatus is applicable in the 3D printer, and before the step of controlling a supply corresponding to a current feeding channel to return to a set position, the method further includes:
sending a stop signal to the 3D printer to cause the printhead of the 3D printer to move to a set position and cause the printhead to suspend executing a printing action; and
after the step of controlling a supply corresponding to the target feeding channel to advance by a second preset distance, the method further includes:
sending a start signal to the 3D printer, to cause the 3D printer to start a material cleaning procedure to clean up a supply leaking from a nozzle of the printhead during replacement of the supply; or to cause the 3D printer to print a supply in the nozzle of the printhead of the 3D printer at a preset position or extrude the supply into a waste area.

Optionally, the multi-supply automatic switching extrusion apparatus is provided with indicator lights corresponding to the feeding channels, for indicating states of use of the feeding channels; and after identifying a target feeding channel corresponding to the supply replacement signal, the method further includes:
controlling an indicator light corresponding to the target feeding channel to operate in a set mode.

According to a second aspect of the present invention, provided is a computer-readable storage medium configured to store a program code, the program code being configured to perform a printing control method according to any embodiment in the first aspect.

According to a third aspect of the present invention, provided is a multi-supply automatic switching extrusion apparatus, including a processor and a memory, wherein
the memory is configured to store a program code and transmit the program code to the processor; and
the processor is configured to perform, according to instructions in the program code, a printing control method according to any embodiment in the first aspect.

The present invention provides a printing control method, a storage medium, and a multi-supply automatic switching extrusion apparatus. The printing control method provided by the present invention is applicable in the multi-supply automatic switching extrusion apparatus. During printing by the 3D printing device, a corresponding target feeding channel can be automatically identified if a supply replacement signal is acquired, thus realizing replacement of a printing supply and implementing the automatic switching of multiple supplies without requiring manual operation. Moreover, by transforming the supplies from multiple feeding channels to a common discharging channel, smooth delivery of the supplies is ensured, and the load burden on an extrusion motor is reduced. Further, the printing method provided by the present invention can implement the automatic switching of the multiple supplies without requiring manual operation, and an irregular part at the front end of a supply can be cut off when the supply is returning, thus ensuring that blocking and jamming of the supply are avoided when the supply is used again, realizing the replacement of the supply in a simple manner and facilitating multi-color printing by the 3D printer.

The above description is merely a summary of the technical solutions of the present invention. To make the technical means of the present invention more clearly understood and implemented according to the contents of the description, and to make the above and other objectives, features, and advantages of the present invention more obvious and comprehensible, the embodiments of the present invention are described in detail below.

The above and other objectives, advantages and features of the present invention will be understood by those skilled in the art more clearly with reference to the detailed description of the specific embodiments of the present invention below with reference to the accompanying drawings.

### BRIEF DESCRIPTION OF THE DRAWINGS

Various other advantages and benefits will become apparent to those of ordinary skill in the art by reading the following detailed description of the preferred embodiments. The accompanying drawings are for the purpose of illustrating the preferred embodiments only and are not considered as limitations to the present invention. Moreover, the same components are denoted by the same reference signs throughout the drawings. In the figures:

FIG. 1 shows a schematic structural diagram of a multi-supply automatic switching extrusion apparatus in a 3D printing device according to an embodiment of the present invention;

FIG. 2 shows a schematic diagram of connection between a multi-supply automatic switching extrusion apparatus and a printhead according to an embodiment of the present invention;

FIG. 3 shows a schematic flowchart of a printing control method according to an embodiment of the present invention;

FIG. 4 shows a schematic exploded view of a multi-supply automatic switching extrusion apparatus in a 3D printing device according to an embodiment of the present invention;

FIG. 5A shows a schematic diagram of a supply extrusion module of a multi-supply automatic switching extrusion apparatus according to an embodiment of the present invention;

FIG. 5B shows a schematic diagram of a partial structure of the supply extrusion module of the multi-supply automatic switching extrusion apparatus according to an embodiment of the present invention;

FIG. 6 shows a schematic structural diagram of a camshaft assembly of the supply extrusion module shown in FIG. 5A;

FIG. 7 shows a schematic diagram of the camshaft assembly of the supply extrusion module shown in FIG. 5A;

FIG. 8 shows a schematic diagram of a pressure bar assembly of the supply extrusion module shown in FIG. 5A;

FIG. 9 shows a schematic structural diagram of a supply cutting module of the multi-supply automatic switching extrusion apparatus according to an embodiment of the present invention; and

FIG. 10 shows a schematic diagram of a transition member of the multi-supply automatic switching extrusion apparatus according to an embodiment of the present invention. 100—Feeding channel, 200—Discharging channel, 300—Printhead, 400—Supply extrusion module, 410—Camshaft assembly, 411—Cam, 412—First camshaft stopper, 413—Second camshaft stopper, 414—Bolt, 420—Camshaft motor, 430—Extrusion wheel, 440—Extrusion motor, 450—Pressure bar assembly, 451—Pressure bar, 452—Pressure pulley, 453—Restoring spring, 454—Restoring spring limiting block, 455—Pressure bar slider, 456—Pressure bar shaft, 457—Pressure relief spring, 460—Microswitch PCB, 500—Supply cutting module, 510—Servo motor, 520—Cutter assembly, 521—Blade turntable, 522—Blade, 523—Turntable gland, 530—Discharge assembly, 531—Discharge block, 533—Hook torsion spring, 540—Discharge port assembly, 541—Second bracket, 542—Microswitch PCB, 543—Circular transition block, 544—Discharge port quick connector, 550—First bracket, 600—Housing, 610—Housing cover plate, 620—Housing side plate, 700—Transition member, 710—Baseplate skeleton, 720—Channel cover plate, 800—Waste box, 900—Indicator light.

### DETAILED DESCRIPTION OF THE EMBODIMENTS

Exemplary embodiments according to the present invention will be described in more detail with reference to the accompanying drawings. Although the exemplary embodiments according to the present invention are shown in the accompanying drawings, it should be understood that the present invention can be implemented in various forms and should not be limited by the embodiments set forth herein. Rather, these embodiments are provided for a more thorough understanding of the present invention, and for fully conveying the scope of the present invention to those skilled in the art.

An embodiment of the present invention provides a printing control method, applicable in a 3D printing device having a multi-supply automatic switching extrusion apparatus. The 3D printing device includes the multi-supply automatic switching extrusion apparatus and a 3D printer, and the multi-supply automatic switching extrusion apparatus may be configured to implement automatic switching of supplies of different colors or different materials.

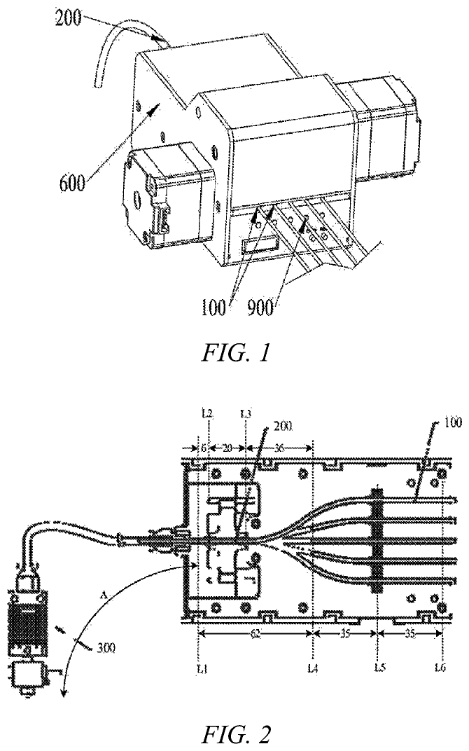

FIG. 1 shows a schematic diagram of an overall structure of a multi-supply automatic switching extrusion apparatus of a 3D printing device according to an embodiment of the present invention. As can be seen from FIG. 1, the multi-supply automatic switching extrusion apparatus described in this embodiment is provided with a plurality of feeding channels 100 and one discharging channel 200. The feeding channels may be configured to accommodate supplies of different colors and materials, and each feeding channel 100 may be connected to the discharging channel 200.

FIG. 2 shows a schematic diagram of connection between the multi-supply automatic switching extrusion apparatus and a printhead of a 3D printer according to an embodiment of the present invention. As shown in FIG. 2, the discharging channel 200 may have one end connected to any one of the feeding channels 100, and the other end connected to a printhead 300 of a 3D printing device. FIGS. 1 and 2 schematically show five feeding channels. In practice, the number of feeding channels may be set according to different requirements, which is not limited in the embodiments of the present invention.

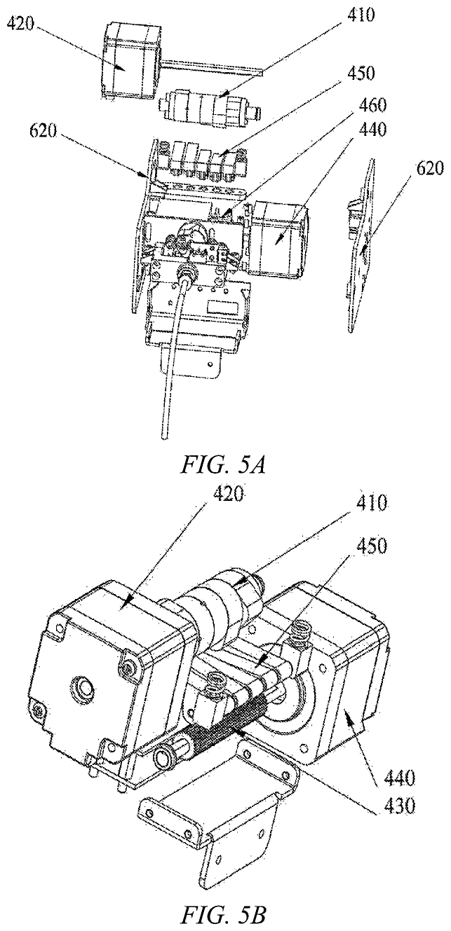

FIG. 4 shows a schematic exploded view of the multi-supply automatic switching extrusion apparatus of the 3D printing device according to an embodiment of the present invention, and FIGS. 5A-10 respectively show schematic diagrams of each component module of the multi-supply automatic switching extrusion apparatus. As can be seen from FIGS. 4-10, the multi-supply automatic switching extrusion apparatus provided in this embodiment may include at least a housing 600, a supply extrusion module 400, a supply cutting module 500 and a transition member 700. The housing 600 includes a housing cover plate 610 and two housing side plates 620.

In this embodiment, the supply extrusion module is configured to drive a supply in the feeding channel to enter the discharging channel or to return.

Referring to FIGS. 4, 5A and 5B, the supply extrusion module 400 may include a camshaft assembly 410, a camshaft motor 420, an extrusion wheel 430, an extrusion motor 440, a pressure bar assembly 450, a microswitch PCB 460, etc.

The camshaft assembly 410 is mounted on the camshaft motor 420, and the camshaft assembly 410 may be driven by the camshaft motor 420 to rotate; the extrusion wheel 430 is connected to the extrusion motor 440, and the extrusion wheel 430 may be driven by the extrusion motor 440 to rotate; and the pressure bar assembly 450 is located between the camshaft assembly 410 and the extrusion wheel 430, a supply may pass between the pressure bar assembly 450 and the extrusion wheel 430, and the supply extrusion module 400 drives, by the camshaft motor 420, the camshaft assembly 410 to selectively depress any pressure bar of the pressure bar assembly 450, such that the supply in the feeding channel, corresponding to the depressed pressure bar, of the plurality of feeding channels 100 is clamped by the extrusion wheel 430, so as to extrude the supply from the corresponding channel. The transition member 700 is located between the pressure bar assembly 450 and the extrusion wheel 430.

The microswitch PCB 460 includes a plurality of feeding position sensors, the number of feeding position sensors corresponds to the number of cams of the camshaft assembly 410, and the feeding position sensors are configured to detect whether supplies are available in the feeding channels corresponding to the cams. If a supply is available in one feeding channel, the feeding position sensor corresponding to the feeding channel sends a material-available signal, and if no supply is available in one feeding channel, the feeding position sensor corresponding to the feeding channel sends a material run-out signal.

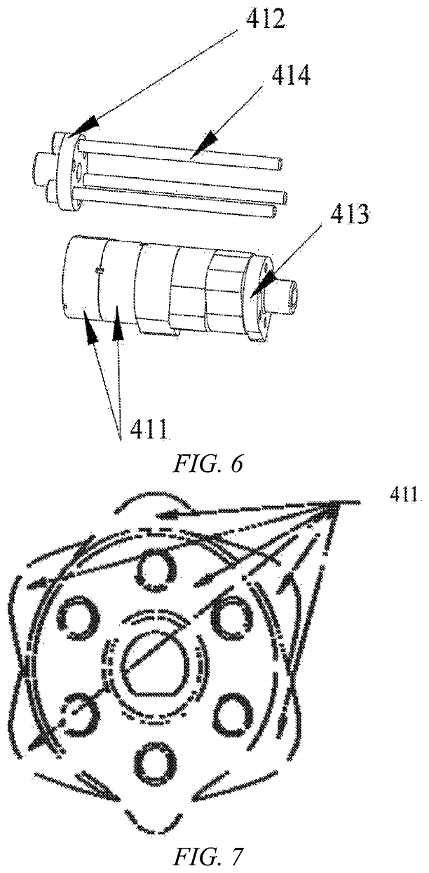

As shown in FIGS. 6-7, the camshaft assembly 410 includes a plurality of staggered cams 411 (five in this embodiment). The plurality of cams 411 are arranged next to each other in sequence, and a first camshaft stopper 412 and a second camshaft stopper 413 are respectively arranged at two sides of the plurality of cams 411. The second camshaft stopper 413 is provided with a protrusion for returning the camshaft motor 420 to zero by means of blocking and interruption of a stepping motor when the camshaft motor 420 returns to zero; and the first camshaft stopper 412, the plurality of cams 411 and the second camshaft stopper 413 are connected in sequence by means of bolts 414.

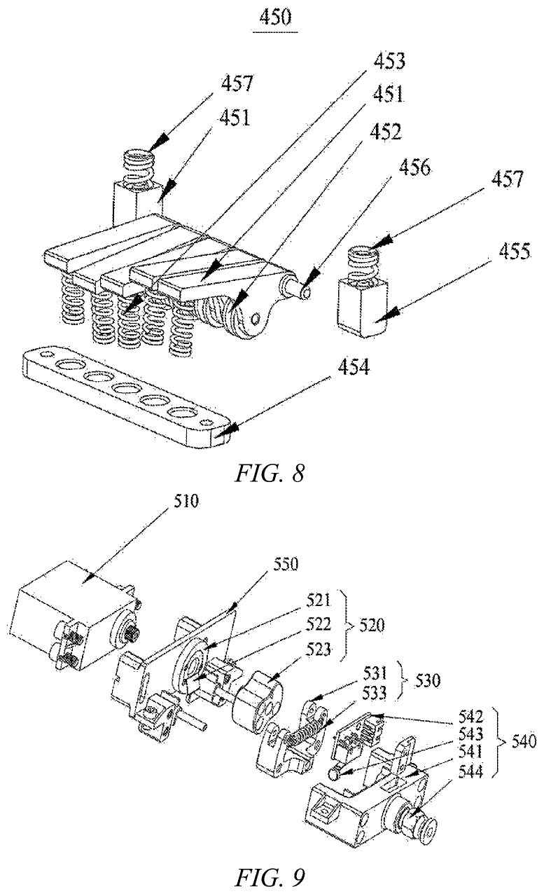

As shown in FIG. 8, the pressure bar assembly 450 includes pressure pulleys 452, restoring springs 453, a restoring spring limiting block 454, pressure bar sliders 455, a pressure bar shaft 456, pressure relief springs 457, and a plurality of pressure bars 451 arranged corresponding to the cams. The number of pressure bars 451 corresponds to the number of feeding channels, and the plurality of pressure bars 451 are arranged side by side. One end of each pressure bar 451 is provided with a through hole allowing the pressure shaft 456 to pass through, so that the plurality of pressure bars 451 are connected to each other by means of the pressure shaft 456. A corresponding pressure pulley 452 is arranged at the bottom of each pressure bar 451 to cooperate with the camshaft assembly 410 for pressing the supply. A restoring spring 453 is mounted at the bottom of each pressure bar 451, and the restoring spring limiting block 454 is arranged corresponding to the restoring springs 453 and is provided with limiting grooves corresponding to the restoring springs 453. When a pressure bar 451 is subjected to an acting force of the cam 411, the corresponding restoring spring 453 is compressed into the corresponding limiting groove of the restoring spring limiting block 454. Two ends of the pressure shaft 456 are each provided with a pressure bar slider 455, the pressure bar slider 455 is provided with a pressure relief spring 457, and the pressure relief spring 457 is located on a side of the pressure bar slider 455 away from the extrusion wheel 430. When the pressure bar 451 bears excessive pressure, the pressure bar slider 455 compresses the pressure relief spring 457 in an opposite direction to the pressure.

The five cams 411 may be assembled adjacent to each other and staggered by 60°, so that only one of the pressure bars is depressed at a time when the camshaft motor 420 drives the camshaft assembly 410 to rotate. When the camshaft assembly 410 is at 0°, the extrusion wheel 430 may be in a neutral state, i.e., none of the pressure bars of the first to fifth channels is depressed, and the supplies are all in a released state; when at 60°, the camshaft assembly 410 depresses the first pressure bar, so that the supply in the first channel is in a pressed state and the second to fifth channels are in the released state; when at 120°, the camshaft assembly 410 depresses the second pressure bar, so that the supply in the second channel is in a pressed state and the first and third to fifth channels are in the released state; and so on.

In addition, in this embodiment, the pressure pulley 424 and the camshaft assembly 410 cooperate to press the supply, so that when a lobe of the cam 411 is gradually turned to the position of the pressure bar 451, the restoring spring 453 is gradually compressed, and the pressure pulley 452 presses the supply; and when the lobe of the cam 411 is gradually turned away from the position of the pressure bar 451, the restoring spring 453 starts to be restored, and the pressure pulley 452 releases the supply and returns the pressure bar 451 to its initial position. In case of an excessive downward pressure, the pressure bar slider 455 compresses the pressure relief spring 457 upwardly, so that the force of pressing the supply between the pressure pulley 452 and the extrusion wheel 430 is within a certain range to avoid damaging the supply.

In an embodiment of the present invention, as shown in FIG. 4, the multi-supply automatic switching extrusion apparatus includes a supply cutting module 500 arranged on the discharging channel. The supply cutting module 500 is mainly configured to cut off an irregular part at the front end of a supply when the supply is returning, discharge the cut-off part of the supply out of the channel, and record a returning signal by means of a discharging position sensor correspondingly arranged in the discharging channel.

Referring to FIG. 9, the supply cutting module 500 may include a servo motor 510, a cutter assembly 520, a discharge assembly 530, a discharge port assembly 540 and a first bracket 550. The cutter assembly 520 and the discharge assembly 530 are arranged between the servo motor 510 and the discharge port assembly 540, and are fixedly connected to the servo motor 510 by means of the first bracket 550 to jointly form the discharging channel. The cutter assembly 520 and the discharge assembly 530 are both connected to the servo motor 510.

When the supply returns to a proper position, the servo motor 510 drives the discharge assembly 530 to clamp the supply, the servo motor 510 also drives the cutter assembly to cut off the supply, and the servo motor 510 also drives the discharge assembly to release the cut-off section of the supply to discharge the cut-off supply.

The cutter assembly 520 includes a blade turntable 521, a blade 522, a turntable gland 523, a turntable connecting bolt (not shown), etc. The blade turntable 521 is provided with a retaining groove for limiting the blade, the blade 522 is mounted in the retaining groove on the blade turntable 521, the turntable gland 523 is then mounted to press the blade 522, and the turntable 521 and the turntable gland 523 may be fixed by means of the turntable connecting bolt. A surface of the turntable gland 523 includes an arc-shaped portion and a recessed portion, and the turntable gland 523 is configured to be in contact with the discharge assembly 530.

The discharge assembly 530 includes a discharge block 531, a bearing (not shown), a hook torsion spring 533, and a bearing connecting bolt (not shown). The supply cutting module 500 shown in FIG. 9 is provided with two discharge blocks 531. The two discharge blocks 531 are symmetrically arranged and form an accommodating space for accommodating the cutter assembly 520. A first end of each discharge block 531 is provided with a groove for accommodating a bearing, and the bearing is arranged in the groove on the discharge block 531. The hook tension spring 533 is also located at the first end of the discharge block 531. Two ends of the hook tension spring 533 are provided with through holes for the bearing connecting bolts to pass through. The two bearing connecting bolts pass through the hook tension spring 533 and the bearing in sequence, thus fixedly connecting the hook tension spring 533 to the discharge block 531. A second end of the discharge block 531 is opposite to the first end, and the second end of the discharge block 531 is configured to hold the supply. The first end of the discharge block 531 is in contact with the turntable gland 523, and the turntable gland 523 rotates with the driving of the servo motor. When the first ends of the discharge blocks 531 are in contact with the arc-shaped portion of the turntable gland 523, the distance between the second ends of the discharge blocks 531 remains unchanged, so that the supply can be clamped. When the second ends of the discharge blocks 531 are in contact with the recessed portion of the turntable gland 523, the distance between the first ends of the two discharge blocks 531 is reduced under the tensile force of the hook tension springs 533, and the distance between the second ends of the two discharge blocks 531 is increased, so that the supply can be released or the clamped supply can be discharged.

The position of the blade 522 corresponds to the recessed portion of the turntable gland 523, so that the blade 522 can cut off the supply when the second ends of the two discharge blocks 531 clamp the supply.

The discharge port assembly 540 includes a second bracket 541, a microswitch PCB 542, a circular transition block 543, a discharge port quick connector 544, a discharging position sensor, etc. The microswitch PCB 542 is arranged on a side of the second bracket 541 close to the discharge assembly 530, and the second bracket 541 is provided with the circular transition block 543 for connection with the discharge port quick connector 544. The discharging position sensor may be a discharge port microswitch or other sensing devices. The second bracket 541 may be fixedly connected to the first bracket 550, to fixedly connect the cutter assembly 520, the discharge assembly 530 and the discharge port assembly 540. The discharge port assembly 540 is configured to acquire, after entering a material replacement/return program, an on/off signal of the microswitch before and after the front end of the supply passes through the circular transition block 543. When the front end of the supply does not pass through the circular transition block 543, an elastic piece corresponding to the discharging position sensor is pushed up by the circular transition block 543, and the discharging position sensor is closed. When the front end of the supply passes through the circular transition block 543, the circular transition block 543 is depressed by the elastic piece of the discharge port microswitch, and the discharging position sensor is turned on.

When the front end of the supply (the front end of the supply is about 12-18 mm) returns to a preset position of the discharging channel after entering the material replacement/return program, the discharge block 531 clamps the end portion of the supply, the cutter assembly 520 starts to work, the servo motor 510 drives the blade 521 to rotate from 0° to 50°, and at this time, a cutting edge of the blade 521 passes through a common end outlet of the transition member 700 to cut off the supply (FIG. 2.10.2). When the cutter assembly 520 further rotates from 50° to 110°, the cam profile of the turntable gland 523 becomes smaller, the hook tension spring 533 pulls the discharge block 531 closer, and ½ of the channel opening is opened, so that the discharge block 531 releases the cut-off end portion of the supply, and at the same time, the cut-off supply is discharged out of the channel and drops into a waste box 800. Then, the servo motor 510 rotates back to 0°. At this time, the supply cutting module 500 completes one operating cycle and waits for a next instruction of the material replacement/return program.

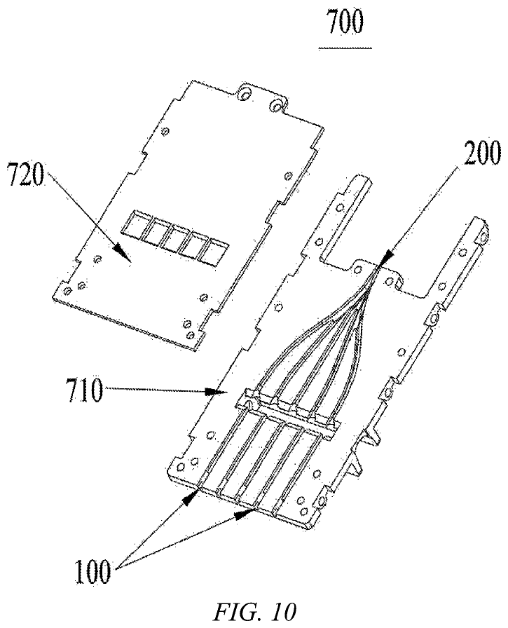

The transition member 700 is a five-to-one transition member and, as shown in FIG. 10, includes a baseplate skeleton 710 and a channel cover plate 720, for realizing conversion of five feeding channels for the supplies into one channel for output. The transition member 700 is provided with five vertical openings for giving way to the pressure pulleys 452, so that when a cam 411 is depressed, the respective pressure pulley 452 descends synchronously to clamp the supply.

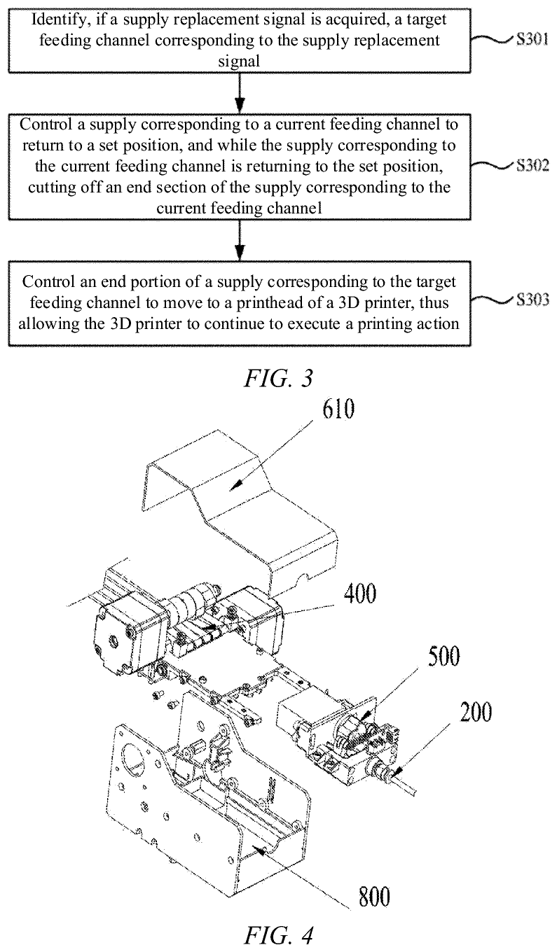

As shown in FIG. 3, an embodiment of the present invention provides a printing control method applicable in the multi-supply automatic switching extrusion apparatus as described above. The multi-supply automatic switching extrusion apparatus is configured to cooperate with a 3D printer including a printhead. The multi-supply automatic switching extrusion apparatus is provided with a supply extrusion module for driving a supply in a feeding channel to enter a discharging channel or to return. The multi-supply automatic switching extrusion apparatus further includes a plurality of feeding channels, one discharging channel, and a cutting module on the discharging channel. The printing control method may include at least steps S301-S303.

At step S301, if a supply replacement signal is acquired, a target feeding channel corresponding to the supply replacement signal is identified. A 3D printer of a 3D printing device executes a printing action. Generally, a three-dimensional model to be printed is sliced by slicing software to generate a print file identifiable by the 3D printer, and the printing may be executed after the 3D printer reads the print file. When the 3D printer executes a printing model, a feeding channel corresponding to a required supply may be selected from a plurality of feeding channels according to parameters in the print file and connected to a discharging channel to execute the printing action. Further, during printing by the 3D printing device, there may be a case of material switching. Therefore, if the supply replacement signal is acquired, a supply switching procedure may be entered, and at the same time, it is necessary to identify the target feeding channel corresponding to the supply replacement signal, i.e., a feeding channel where the required supply is correspondingly stored in subsequent printing. As can be seen from FIGS. 1 and 2, the multi-supply automatic switching extrusion apparatus is provided with a plurality of feeding channels and one discharging channel, and the target feeding channel corresponding to the supply replacement signal may be any one of the plurality of feeding channels to be switched.

The supply replacement signal is an instruction signal automatically triggered by the 3D device or triggered by a user for instructing the 3D printing device to switch the supply. The supply replacement procedure may be entered if the 3D printing device acquires the supply replacement signal. In case of different triggering timings and different triggering objects of the supply replacement signal, different target feeding channels may be correspondingly switched, which can be set in advance in the print file or in a printing procedure of the 3D device and is not limited in the embodiments of the present invention.

At step S302, a supply corresponding to a current feeding channel is controlled to return to a set position, and while the supply corresponding to the current feeding channel is returning to the set position, an end portion of the supply corresponding to the current feeding channel is cut off.

When a supply needs to be replaced, since the supply being used is still in the printhead of the 3D printer, directly controlling the supply that needs to be replaced to move forward may cause a conflict with the supply originally left in the printhead, failing to complete feeding of the supply that needs to be replaced. In the present application, the supply corresponding to the current feeding channel is first controlled to return to the set position.

The exact location of the set position is not limited as long as feeding of the supply in the target feeding channel is not affected. For example, the end portion of the supply in the current feeding channel returns to a certain position in the current feeding channel.

The supply cutting module may also cut off the end portion of the supply during returning. During operation of the printer, if the end portion of the supply returns when melted in the printhead, a bump may be formed at the end portion of the supply, which may affect the next use. That is, if the returned supply becomes the supply corresponding to the target feeding channel later, the bump at the end portion of the supply may affect the entry of the supply into the printhead when the supply advances to the printhead, which may result in inability to continue printing. Therefore, in this embodiment, the end portion of the returned supply is cut off, avoiding a bump at the end portion of the used supply, so that the subsequent printing will not be affected.

The supply may stop returning while being cut off, and the supply continues to return after the end portion of the supply is cut off.

The supply cutting module 500 as described above may be adopted to cut off the supply. It can be understood that in the method of the present application, other structures may also be adopted to cut off the supply as long as the supply can be cut off.

After being cut off, the supply may be discharged out of the discharging channel, for example, may be discharged into a waste box.

At step S303, an end portion of a supply corresponding to the target feeding channel is controlled to move to the printhead of the 3D printer, thus allowing the 3D printer to continue to execute a printing action.

After the supply returns to the set position, the end portion of the supply corresponding to the target feeding channel may be moved to the printhead of the 3D printer, and the 3D printhead may perform printing with the supply in the target feeding channel.

It can be understood that a control chip may be provided in the multi-supply automatic switching extrusion apparatus to perform the printing control method according to the present application, or a control chip may be provided in the 3D printer of the 3D printing device to perform the printing control method according to the present application.

The printing control method provided in this embodiment includes: if a supply replacement signal is acquired, identifying a target feeding channel corresponding to the supply replacement signal; controlling a supply corresponding to a current feeding channel to return to a set position, and while the supply corresponding to the current feeding channel is returning to the set position, controlling a supply cutting module to cut off an end portion of the supply corresponding to the current feeding channel; and controlling, by a supply extrusion module, an end portion of a supply corresponding to the target feeding channel to move to a printhead of a 3D printer, thus allowing the 3D printer to continue to execute a printing action. Therefore, the automatic switching of multiple supplies can be implemented without requiring manual operation, and an irregular part at the front end of a supply can be cut off when the supply is returning, thus ensuring that blocking and jamming of the supply are avoided when the supply is used again, realizing the replacement of the supply in a simple manner and facilitating multi-color printing by the 3D printer.

In this embodiment, the step of, if a supply replacement signal is acquired, identifying a target feeding channel corresponding to the supply replacement signal may include: if a preset supply replacement signal is read in a print file, identifying a target feeding channel corresponding to the supply replacement signal.

Generally, the 3D printer performs printing according to a G-code, i.e., the 3D printing device needs to implement printing of a 3D model according to a G-code file. Therefore, in this embodiment, it is possible that during execution of printing by the 3D printing device according to the G-code file, if a command code related to the supply replacement signal is read in the G-code file, the target feeding channel corresponding to the supply replacement signal may be identified. The method provided in this embodiment can automatically identify the supply replacement signal in the print file during the execution of printing by the 3D printing device, so as to further automatically identify the target feeding channel of the plurality of feeding channels in the corresponding 3D printing device according to the supply replacement signal.

Before the step of controlling a supply corresponding to a current feeding channel to return to a set position, the printing control method further includes: sending a stop signal to the 3D printer to cause the printhead of the 3D printer to move to a set position and cause the printhead to suspend executing a printing action.

Upon acquisition of the supply replacement signal, a stop signal may be sent to the 3D printer, and if the 3D printer receives the stop signal, the 3D printer controls the printhead to move to the set position. In this embodiment, the set position may be a safe position of the printhead in an unprinted state. In the safe position, the contact with the printed 3D model may be avoided. It should be noted that a hotbed and an extrusion heating state of the 3D printer are maintained during suspension of printing by the printhead. In addition, the printhead may not damage the model in a heating state when moving to the set position, thus improving the printing accuracy.

The step S302 of controlling a supply corresponding to a current feeding channel to return to a set position, and while the supply corresponding to the current feeding channel is returning to the set position, cutting off an end portion of the supply corresponding to the current feeding channel may include steps A1-A3.

At step A1, a supply corresponding to a current feeding channel is controlled by the supply extrusion module to return to a first set position.

The supply extrusion module may control advancement and returning of the supply. The exact location of the first set position is not limited. The first set position may be located between the feeding channel and the discharging channel, or located on the discharging channel. The supply may stop moving after returning to the first set position.

At step A2, the supply cutting module is controlled to cut off an end portion of the supply corresponding to the current feeding channel.

A blade 502 of the supply cutting module may rotate to cut off the supply, so as to cut off a probable bump at the end portion of the supply, facilitating the subsequent use of the supply. The supply cutting module is controlled to cut off the end portion of the supply corresponding to the current feeding channel, and the supply is controlled to stop moving, thus facilitating the cutting of the supply.

At step A3, the supply corresponding to the current feeding channel is controlled by the supply extrusion module to return to a second set position.

The second set position may be located inside the feeding channel, and each feeding channel may be provided with a second set position. The second set position may be located inside the feeding channel such that the supply in the current feeding channel will not affect the use of the target feeding channel.

In an embodiment of the present application, the supply corresponding to the current feeding channel is controlled by the supply extrusion module to return to the first set position; the supply cutting module is controlled to cut off the end portion of the supply corresponding to the current feeding channel; and the supply corresponding to the current feeding channel is controlled by the supply extrusion module to return to the second set position, and the supply may be cut off to remove a probable bump at the end portion of the supply, facilitating the subsequent use of the supply, so that the supply in the current feeding channel will not affect the use of the target feeding channel.

The discharging channel is correspondingly provided with a discharging position sensor, and each feeding channel is correspondingly provided with a feeding position sensor; and the step A1 of controlling, by the supply extrusion module, a supply corresponding to a current feeding channel to return to a first set position includes: controlling, by the supply extrusion module, the supply corresponding to the current feeding channel to return, and if a material run-out signal corresponding to the discharging position sensor is acquired, controlling, by the supply extrusion module, the supply corresponding to the current feeding channel to further return by a first preset distance.

After the supply is further returned by the first preset distance, the end portion of the supply is located at the first set position.

The returning of the supply may be controlled by the supply extrusion module. The material run-out signal indicates that there is no supply at the corresponding position of the discharging position sensor. If the material run-out signal corresponding to the discharging position sensor is acquired, it indicates that the end section of the returned supply passes through the position corresponding to the discharging position sensor, and based on this position, the supply corresponding to the current feeding channel is controlled to return by the first preset distance, instead of simply controlling the return length of the supply by the supply extrusion module, so that the accuracy of the return position of the supply can be increased. In addition, the corresponding position of the discharging position sensor corresponds to the discharging channel, i.e., the corresponding position of the discharging position sensor is closer to the first set position, which further increases the accuracy of the return position of the supply and facilitates the subsequent cutting of the supply. In addition, the position of the discharging position sensor is different from that of the supply cutting module, so that the discharging position sensor will not hinder cutting of the supply.

In this embodiment, the step A3 of controlling, by the supply extrusion module, the supply corresponding to the current feeding channel to return to a second set position may include: controlling, by the supply extrusion module, the supply corresponding to the current feeding channel to return, and if a material run-out signal corresponding to the feeding position sensor is acquired, stopping, by the supply extrusion module, the movement of the supply corresponding to the current feeding channel.

In this embodiment, if the material run-out signal corresponding to the feeding position sensor is acquired, it indicates that the end portion of the returned supply passes through the position corresponding to the feeding position sensor, i.e., the supply returns to the second set position.

In this embodiment, it is determined, based on the acquisition of the material run-out signal corresponding to the feeding position sensor, that the end portion of the supply returns to the second set position, so that the position determination of the supply is simple and practical, and the efficiency of replacing the supply is improved.

The discharging channel is correspondingly provided with a discharging position sensor, and the step S303 of controlling an end portion of a supply corresponding to the target feeding channel to move to the printhead of the 3D printer may further include steps B1-B2.

At step B1, the supply extrusion module is controlled to switch to a position corresponding to a target feeding channel, and the supply corresponding to the target feeding channel is caused to enter the discharging channel.

The supply extrusion module is controlled to switch to a position corresponding to the target feeding channel such that the cam of the supply extrusion module depresses a pressure pulley corresponding to the target feeding channel, so that the supply extrusion module can control the advancement of the supply in the target feeding channel. The supply can be controlled to advance to the discharging channel when the supply in the target feeding channel can be controlled to advance.

At step B2, if a material-available signal corresponding to the discharging position sensor is acquired, a supply corresponding to the target feeding channel is controlled to advance by a second preset distance.

The material-available signal may be acquired when the supply in the target feeding channel advances to the position of the discharging channel corresponding to the discharging position sensor. The second preset distance is the distance between the position corresponding to the discharging position sensor and the position of the nozzle of the printhead, and the distance may be measured in advance.

In this embodiment, the position of the end portion of the supply is determined by the discharging position sensor, then the supply is controlled to advance by the second preset distance, an initial position of the end portion of the supply can be ignored because the initial position of the supply has no impact on how much the supply advances, and the advancement of the supply is controlled only based on the position of the discharging position sensor, thereby reducing the calculation amount of the advancement of the supply, making the replacement of the supply simpler, and reducing the difficulty in replacing the supply.

Before the step A1 of controlling a supply corresponding to a current feeding channel to return to a first set position, the printing control method may further include: controlling a supply corresponding to a current feeding channel to return; and if a material run-out signal corresponding to the discharging position sensor is acquired, recording a return distance of the supply, and taking the distance as the second preset distance.

The end portion of the supply is still located inside the printhead before the supply corresponding to the current feeding channel returns, and the supply corresponding to the current feeding channel is controlled to return. If the material run-out signal corresponding to the discharging position sensor is acquired, it means that the end portion of the supply returns to the position corresponding to the discharging position sensor. The return distance of the supply, namely the distance between an end portion of the printhead and the position corresponding to the discharging position sensor, is recorded, and this distance does not need to be measured manually by the user. The second preset distance is calculated according to the return length of the supply, so that the obtained second preset distance is more accurate, and errors in the accuracy of the supply measured by the user due to bending of the supply are reduced.

In this embodiment, before the step A1 controlling a supply corresponding to a current feeding channel to return to a first set position, the printing control method may further include: sending a stop signal to the 3D printer, to cause the printhead of the 3D printer to move to a set position and cause the printhead to suspend executing a printing action. That is, before the supply corresponding to the current feeding channel is controlled to return, a stop signal is sent to the 3D printer, and the printhead of the 3D printer is controlled to move to a safe position to avoid a situation in which the supply is returning while the printhead is still working.

After the step B2 of controlling a supply corresponding to the target feeding channel to advance by a second preset distance, the printing control method may further include: sending a start signal to the 3D printer, to cause the 3D printer to start a material cleaning procedure to clean up a supply leaking from a nozzle of the printhead during replacement of the supply; or to cause the 3D printer to print a supply in the nozzle of the printhead of the 3D printer at a preset position or extrude the supply into a waste area. In this embodiment, the aforementioned waste of the printhead may also be cleaned after the printhead is controlled to suspend executing the printing action, ensuring that blocking and jamming are avoided when the supply passes through an extruder.

In an embodiment of the present invention, the multi-supply automatic switching extrusion apparatus is provided with indicator lights corresponding to the feeding channels, for indicating states of use of the feeding channels. After the step S301 of identifying a target feeding channel corresponding to the supply replacement signal, the printing control method may further include: controlling an indicator light corresponding to the target feeding channel to operate in a set mode. As can be seen from FIG. 1, an LED indicator light may be correspondingly arranged below each of the five feeding channels in this embodiment. For example, assuming that the amount of the supply in the first feeding channel is less than a set amount, the light corresponding to the first feeding channel may be controlled to flash constantly to remind relevant staff to replace the supply in the first feeding channel in a timely manner.

Optionally, in addition to the above description, the supply replacement signal may also be a material shortage signal generated when the feeding position sensor in the current feeding channel detects a lack of the supply in the current feeding channel. Optionally, the feeding position sensor may be a feed port microswitch. If a material shortage signal when the feed port microswitch is not triggered by the supply in the feeding channel, the material shortage signal is taken as the supply replacement signal. In this embodiment, each feeding channel may be provided with a feeding position sensor. After a tail end of the supply in the current feeding channel passes through the feeding position sensor in the current feeding channel, the feeding position sensor is triggered to generate a material shortage signal, indicating that the amount of the supply in the current feeding channel is less than the set amount. When the 3D printer detects that the material shortage signal is generated by the feeding position sensor in the current feeding channel, the material shortage signal may be used as the supply replacement signal, so as to execute the action of replacing the supply. The method provided in this embodiment may be suitable for the 3D printer to perform automatic switching and continuous printing of multiple rolls of supplies corresponding to the plurality of feeding channels, and can implement switching and printing of five rolls of supplies as required according to slicing data, thus achieving an automatic switching and printing function of the five rolls of supplies.

In an embodiment of the present invention, if the feeding channel needs to be switched again and the new target feeding channel is determined as the current feeding channel for the first time, the current feeding channel is skipped, and a prompt message is sent or the next channel of the current feeding channel is taken as the new target feeding channel. As described above, the supply replacement signal is triggered when the amount of the supply in the current feeding channel is less than the set amount. Assuming that a new target feeding channel is the current feeding channel corresponding to the previously triggered supply replacement signal when the 3D printer performs automatic switching and continuous printing of multiple rolls of supplies corresponding to the plurality of feeding channels, the current feeding channel may be skipped, and a prompt message indicating a lack of the supply may be sent, or the next channel of the current feeding channel is automatically taken as the new target feeding channel. Therefore, the influence of the lack of the supply on the printing procedure of the 3D model is avoided.

The printing control method described above will be described in detail below with reference to FIG. 2. In FIG. 2, the dotted line L1 indicates a position corresponding to the discharging position sensor, a position corresponding to the discharge block channel lies between the dotted line L2 and the dotted line L3, the dotted line L3 indicates a position corresponding to the blade of the supply cutting module, the dotted line L4 indicates a position corresponding to a waiting point for preparing a supply, the dotted line L5 indicates a position corresponding to the extrusion wheel 430, and the dotted line L6 indicates a position corresponding to the feeding position sensor. FIG. 2 shows the distances between the dotted lines in millimeters.

### Embodiment 1

At step A1, the 3D printer is currently printing a supply in a first channel, and if the 3D printer reads a supply replacement signal corresponding to a preset G code in a print file, a target feeding channel corresponding to the supply replacement signal is identified as a supply signal of a third channel.

At step A2, a printhead of the 3D printer is controlled to move to a set position, such that the printhead is not in contact with a printing model, the printhead is controlled to suspend executing a printing action, and at this time, a hotbed and an extrusion heating state of the 3D printer are maintained.

At step A3, the supply corresponding to the first channel is controlled to return, and a return distance of the supply is recorded if a material run-out signal corresponding to a discharging position sensor is acquired. Specifically, an extrusion motor quickly returns and starts to record the return distance, and if the discharging position sensor is turned on after an end portion of the supply passes through the discharging position sensor of the supply cutting module, a distance A between the nozzle of the printhead and a discharge port microswitch is recorded.

At step A4, at the same time, the extrusion motor continues to return by 10 mm, the supply cutting module starts to cut off an irregular part (about 16 mm in length) at the end portion of the supply, and the cut-off supply is discharged out of the channel and drops into a waste box.

At step A5, after the extrusion motor continues to return by 36 mm, the front end of the supply stops in a waiting area, and the extrusion motor stops working.

At step A6, a supply extrusion module is switched to the position of the third channel (a camshaft motor drives a camshaft assembly to rotate to 180°, and a cam for the third channel depresses a pressure bar). At this time, the extrusion motor starts to work and extrudes the supply in the third channel, the supply is extruded forward until the front end of the supply pushes up the discharging position sensor of the supply cutting module, the discharging position sensor is closed, an extrusion distance M1 is calculated, and when M1=A, it is believed that the supply in the third channel has been transported to the position of the nozzle of the printhead.

At step A7, a start signal is sent to the 3D printer, to cause the 3D printer to start a material cleaning procedure to clean up the supply originally left in the nozzle during replacement of a supply and to print the remaining supply in a preset position, for example, on a cleaning tower, or to cause the 3D printer to directly extrude the supply in the nozzle of the printhead of the 3D printer into a waste area of the printer. In the material cleaning program, an extrusion length is about 20 mm.

At step A8, a supply switching program ends, printing resumes, and printing of the supply in the third channel begins.

### Embodiment 2

At step B1, the 3D printer is currently printing a supply corresponding to a first channel and detects a supply replacement signal generated when the amount of the supply in the first channel is less than a set amount, and a target feeding channel corresponding to the supply replacement signal is determined as a second channel. After a tail end of the supply in the first channel passes through a feeding position sensor of the first channel, a material shortage signal generated when the feeding position sensor is turned on is used as the supply replacement signal.

At step B2, a printhead of the 3D printer is controlled to move to a set position, such that the printhead is not in contact with a printing model, the printhead is controlled to suspend executing a printing action, and at this time, a hotbed and an extrusion heating state of the 3D printer are maintained.

At step B3, the supply corresponding to the first channel is controlled to return, and a return distance of the supply is recorded if a material run-out signal corresponding to a discharging position sensor is acquired. Specifically, an extrusion motor quickly returns and starts to record the return distance, the discharging position sensor is turned on after the front end of the supply passes through the discharging position sensor of the supply cutting module, and at this time, a distance A between nozzle and a discharge port microswitch is recorded.

At step B4, at the same time, the extrusion motor continues to return by 10 mm, the supply cutting module starts to cut off an irregular part (about 16 mm in length) at the front end of the supply, and the cut-off supply is discharged out of the channel and drops into a waste box.

At step B5, after the extrusion motor continues to return by 36 mm, the front end of the supply stops in a waiting area, and the extrusion motor stops working.

At step B6, a supply extrusion module is switched to the position of the second channel (a camshaft motor drives a camshaft assembly to rotate to 120°, and a cam for the second channel depresses a pressure bar) in the order of first to fifth channels. At this time, the extrusion motor starts to work and extrudes the supply in the second channel, the supply is extruded forward until the front end of the supply pushes up the discharging position sensor of the supply cutting module, the discharging position sensor is turned on, an extrusion distance M2 is calculated, and when M2=A, it is believed that the supply in the second channel has been transported to the position of the nozzle of the printhead.

At step B7, a start signal is sent to the 3D printer, to cause the 3D printer to start a material cleaning procedure, and the printer starts the material cleaning program to clean up the supply leaking from the nozzle during waiting.

At step B8, printing resumes after a supply switching program ends, and printing of the supply corresponding to the second channel begins. In this embodiment, an indicator light of the first channel keeps flashing after the remaining supply in the first channel returns, and at this time, it is believed that the supply in the first channel is used up and needs to be replaced. When it is the turn of the supply in the first channel again by switching in order, the first channel is directly skipped and the next channel is selected. The indicator light of the first channel turns red and is always on after the remaining supply in the first channel is pulled out, at this time, it is believed that the supply in the first channel is vacant, and when it is the turn of the supply of the first channel again by switching in order, the first channel is directly skipped and the next channel is selected. The indicator light of the first channel turns green and is always on after a new supply is inserted into the first channel, and when it is the turn of the supply of the first channel again by switching in order, the supply in the first channel can be selected normally.

An embodiment of the present invention also provides a computer-readable storage medium for storing a program code. The program code is configured to perform a printing control method described in the foregoing embodiments.

An embodiment of the present invention also provides a multi-supply automatic switching extrusion apparatus, including a processor and a memory, where the memory is configured to store a program code and transmit the program code to the processor; and the processor is configured to execute, according to instructions in the program code, a printing control method according to the foregoing embodiments.

An embodiment of the present invention also provides a 3D printing device, which is provided with a multi-supply automatic switching extrusion apparatus according to the foregoing embodiments. In addition, the 3D printing device may further include the multi-supply automatic switching extrusion apparatus as described above, a printhead, a nozzle, and other assemblies.

Those skilled in the art can clearly understand that the specific working processes of the systems, apparatuses, modules and units described above may refer to the corresponding processes in the above embodiments of the method and will not be further described herein for the sake of brevity.

In addition, according to the embodiments of the present invention, all the functional units may be physically independent of each other, or two or more functional units may be integrated together, or all the functional units may be integrated in one processing unit. The above integrated functional unit may be implemented either in the form of hardware or in the form of software or firmware. It will be understood by those of ordinary skill in the art that if the integrated functional unit is implemented in the form of software and sold or used as an independent product, it may be stored in a computer-readable storage medium.

Based on such an understanding, the technical solution of the present invention essentially, or all or part of the technical solution may be embodied in the form of a software product. The computer software product is stored in a storage medium and includes several instructions to cause a computing device (such as a personal computer, a server or a network device) to execute all or some steps of the method described in the embodiments of the present invention when running the instructions. The foregoing storage medium includes: a USB flash disk, a removable hard disk, a read-only memory (ROM), a random access memory (RAM), a magnetic disk or an optical disk and other media that can store program codes.

Alternatively, all or some of the steps of implementing the foregoing method embodiments may be completed by hardware (a computing device such as a personal computer, a server, or a network device) relevant to program instructions. The program instructions may be stored in a computer-readable storage medium, and, when executed by a processor of the computing device, cause the computing device to perform all or some of the steps of the method according to the embodiments of the present invention.

At last, it should be noted that the foregoing embodiments are only for illustrating, but not limiting, the technical solutions of the present invention. Although the present invention has been described in detail with reference to the foregoing embodiments, it should be understood by those of ordinary skill in the art that modifications may still be made to the technical solutions described in the foregoing embodiments within the spirit and principles of the present invention, or equivalent substitutions may be made for some or all of the technical features; and these modifications or substitutions do not make the corresponding technical solutions depart from the scope of protection of the present invention.

What is claimed is:

1. A printing control method, applicable in a multi-supply automatic switching extrusion apparatus, the multi-supply automatic switching extrusion apparatus is configured to cooperate with a 3D printer comprising a printhead, the method comprising:
if a supply replacement signal is acquired, identifying a target feeding channel corresponding to the supply replacement signal;
cutting off an end portion of the supply corresponding to the current feeding channel; and
controlling an end portion of a supply corresponding to the target feeding channel to move to the printhead of the 3D printer, thus allowing the 3D printer to continue to execute a printing action.

2. The printing control method according to claim 1, further comprising:
if a preset supply replacement signal is read in a print file, identifying a target feeding channel corresponding to the supply replacement signal.

3. The printing control method according to claim 1, wherein the multi-supply automatic switching extrusion apparatus is provided with a supply extrusion module for driving a supply in the feeding channel to enter the discharging channel or to return, the multi-supply automatic switching extrusion apparatus further comprises a plurality of feeding channels, one discharging channel, and a cutting module on the discharging channel, further comprising:
controlling the supply cutting module to cut off an end portion of the supply corresponding to the current feeding channel; and
controlling, by the supply extrusion module, the supply corresponding to the current feeding channel to return to a second set position.

4. The printing control method according to claim 3, further comprising:
controlling, by the supply extrusion module, a supply corresponding to a current feeding channel to return to a first set position.

5. The printing control method according to claim 3, wherein a discharging position sensor is provided in the discharging channel, feeding position sensors are provided in the feeding channels; further comprising:
controlling, by the supply extrusion module, the supply corresponding to the current feeding channel to return, and if a material run-out signal corresponding to the feeding position sensor is acquired, stopping, by the supply extrusion module, the movement of the supply corresponding to the current feeding channel.

6. The printing control method according to claim 3, wherein a discharging position sensor is provided in the discharging channel, feeding position sensors are provided in the feeding channels; further comprising:
controlling, by the supply extrusion module, the supply corresponding to the current feeding channel to return, and if a material run-out signal corresponding to the discharging position sensor is acquired, controlling, by the supply extrusion module, the supply corresponding to the current feeding channel to further return by a first preset distance.

7. The printing control method according to claim 1, wherein the multi-supply automatic switching extrusion apparatus is provided with a supply extrusion module for driving a supply in the feeding channel to enter the discharging channel or to return, the multi-supply automatic switching extrusion apparatus further comprises a plurality of feeding channels, one discharging channel, and a cutting module on the discharging channel, the discharging channel is correspondingly provided with a discharging position sensor, and the step of controlling an end portion of a supply corresponding to the target feeding channel to move to the printhead of the 3D printer comprises:
controlling the supply extrusion module to switch to a position corresponding to a target feeding channel, and causing the supply corresponding to the target feeding channel to enter the discharging channel; and
if a material-available signal corresponding to the discharging position sensor is acquired, controlling a supply corresponding to the target feeding channel to advance by a second preset distance.

8. The printing control method according to claim 7, further comprising:
controlling a supply corresponding to a current feeding channel to return; and
if a material run-out signal corresponding to the discharging position sensor is acquired, recording a return distance of the supply, and taking the distance as the second preset distance.

9. The printing control method according to claim 1, further comprising:
sending a start signal to the 3D printer, to cause the 3D printer to start a material cleaning procedure to clean up a supply leaking from a nozzle of the printhead during replacement of the supply; or to cause the 3D printer to print a supply in the nozzle of the printhead of the 3D printer at a preset position or extrude the supply into a waste area.

10. The printing control method according to claim 1, wherein the multi-supply automatic switching extrusion apparatus is provided with indicator lights corresponding to the feeding channels, for indicating states of use of the feeding channels; further comprising:
controlling an indicator light corresponding to the target feeding channel to operate in a set mode.

11. A multi-supply automatic switching extrusion apparatus, comprising a processor and a memory, wherein
the memory is configured to store a program code and transmit the program code to the processor; and
the processor is configured to perform, according to instructions in the program code, the printing control method according to claim 1.

12. The multi-supply automatic switching extrusion apparatus according to claim 11, wherein the processor is further configured to perform, according to instructions in the program code:
if a preset supply replacement signal is read in a print file, identifying a target feeding channel corresponding to the supply replacement signal.

13. The multi-supply automatic switching extrusion apparatus according to claim 11, wherein the multi-supply automatic switching extrusion apparatus is provided with a supply extrusion module for driving a supply in the feeding channel to enter the discharging channel or to return, the multi-supply automatic switching extrusion apparatus further comprises a plurality of feeding channels, one discharging channel, and a cutting module on the discharging channel, further comprising:
controlling the supply cutting module to cut off an end portion of the supply corresponding to the current feeding channel; and
controlling, by the supply extrusion module, the supply corresponding to the current feeding channel to return to a second set position.

14. The multi-supply automatic switching extrusion apparatus according to claim 13, wherein the processor is further configured to perform, according to instructions in the program code:
controlling, by the supply extrusion module, a supply corresponding to a current feeding channel to return to a first set position.

15. The multi-supply automatic switching extrusion apparatus according to claim 13, wherein a discharging position sensor is provided in the discharging channel, feeding position sensors are provided in the feeding channels; further comprising:
controlling, by the supply extrusion module, the supply corresponding to the current feeding channel to return, and if a material run-out signal corresponding to the feeding position sensor is acquired, stopping, by the supply extrusion module, the movement of the supply corresponding to the current feeding channel.

16. The multi-supply automatic switching extrusion apparatus according to claim 13, wherein a discharging position sensor is provided in the discharging channel, feeding position sensors are provided in the feeding channels; further comprising:
controlling, by the supply extrusion module, the supply corresponding to the current feeding channel to return, and if a material run-out signal corresponding to the discharging position sensor is acquired, controlling, by the supply extrusion module, the supply corresponding to the current feeding channel to further return by a first preset distance.

17. The multi-supply automatic switching extrusion apparatus according to claim 11, wherein the multi-supply automatic switching extrusion apparatus is provided with a supply extrusion module for driving a supply in the feeding channel to enter the discharging channel or to return, the multi-supply automatic switching extrusion apparatus further comprises a plurality of feeding channels, one discharging channel, and a cutting module on the discharging channel, the discharging channel is correspondingly provided with a discharging position sensor, and the step of controlling an end portion of a supply corresponding to the target feeding channel to move to the printhead of the 3D printer comprises:
controlling the supply extrusion module to switch to a position corresponding to a target feeding channel, and causing the supply corresponding to the target feeding channel to enter the discharging channel; and
if a material-available signal corresponding to the discharging position sensor is acquired, controlling a supply corresponding to the target feeding channel to advance by a second preset distance.

18. The multi-supply automatic switching extrusion apparatus according to claim 17, wherein the processor is further configured to perform, according to instructions in the program code:
controlling a supply corresponding to a current feeding channel to return; and
if a material run-out signal corresponding to the discharging position sensor is acquired, recording a return distance of the supply, and taking the distance as the second preset distance.

19. The multi-supply automatic switching extrusion apparatus according to claim 11, wherein the processor is further configured to perform, according to instructions in the program code:
sending a start signal to the 3D printer, to cause the 3D printer to start a material cleaning procedure to clean up a supply leaking from a nozzle of the printhead during replacement of the supply; or to cause the 3D printer to print a supply in the nozzle of the printhead of the 3D printer at a preset position or extrude the supply into a waste area.

20. The multi-supply automatic switching extrusion apparatus according to claim 11, wherein the multi-supply automatic switching extrusion apparatus is provided with indicator lights corresponding to the feeding channels, for indicating states of use of the feeding channels; and the processor is further configured to perform, according to instructions in the program code:
controlling an indicator light corresponding to the target feeding channel to operate in a set mode.
